(19) United States
(12) Patent Application Publication
(10) Pub. No.: US 2019/0320158 A1
(43) Pub. Date: Oct. 17, 2019

(54) Virtual Veronica

(71) Applicant: Richard Vertucci, Scotch Plains, NJ (US)

(72) Inventor: Richard Vertucci, Scotch Plains, NJ (US)

(21) Appl. No.: 15/951,170

(22) Filed: Apr. 12, 2018

(51) Int. Cl. H04N 13/236; H04N 13/344; G02B 27/01

(52) U.S. Cl. CPC H04N 13/236; G02B 27/017; H04N 13/344

(57) ABSTRACT

Using only 4 mirrors and 5 cheap plastic molded parts the Virtual Veronica was created to be an inexpensive fun to use toy, a new addition to the Virtual Reality game world.

The smart cell phone Implementation is a great place to start. As a lens attachment to the smart cell phone It will create a three-dimensional image (FIG. 2B). That image can be viewed on its self or any smart cell phone in a “Virtual Reality Headset”.

The image can be in the form of a photo, a video or a live stream. It can be immediately “text” to friends or family around the world.

While VR headsets and VR apps are not expensive, interest in their use is not as popular as cell phone photography. An inexpensive toy such as the Virtual Veronica could change that. Anyone with a smart cell phone and no additional software can enter the Realm of “3D Cinemaphotography”. But with the computing and networking power of today's cell phone along with additional software there is no limit as to what can be created!

Here are some additional embodiments of the Virtual Veronica hardware also in the interest of fun. That I have started working on. A stand-alone light weight camera streaming (via WIFI) with a light weight Virtual Veronica for use on a toy drone. A VR headset with the Virtual Veronica built in so that two players can see only through each other's eyes.

Think of the fun! Keep laughing and live longer—Richard Vertucci

### TECHNICAL FIELD

The present invention relates to Three-Dimensional Photography and more particularly to the new gaming industry called VIRTUAL REALITY.

### A BRIEF DESCRIPTION OF THE DRAWINGS

FIG. 1A & 1B—Basis of invention

FIG. 2A & 2B—Resulting image created

FIG. 3A, 3B, 4A, 4B, 5A, 5B—Embodiment for use with a smart cell phone.

### DRAWINGS REFERENCE NUMBERS

11—Right Outer Mirror
12—Right Center Mirror
13—Left Center Mirror
14—Left Outer Mirror
15—Lens of a Camera (reference only, not part of the device)
16—Rear Walls
17—Left Side Wall
18—Right Side Wall
19—Mirror Holders
20—Bottom
21—Stage&Sled (one piece)
22—View Port Hole
23—Stage
24—Light Stop Separator Holder
25—Light Stop Separator
26—Phone Gripper
27—Stage Hole
28—Sled

### DETAILED DESCRIPTIONS

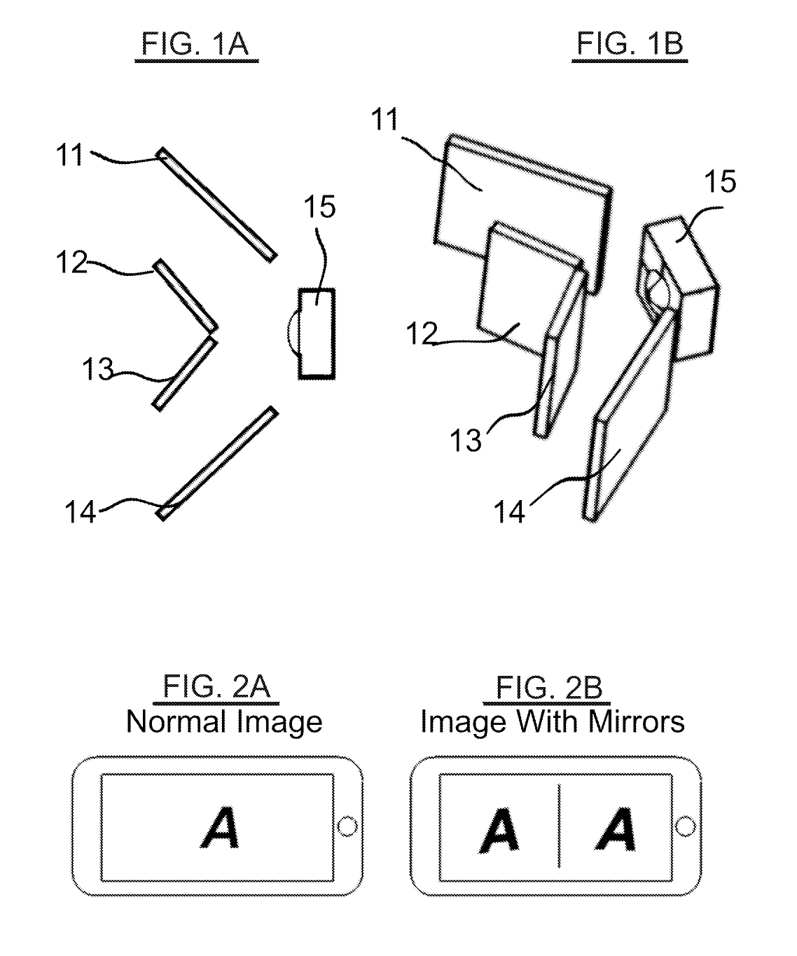

FIG. 1A and FIG. 1B show top and iso view of principal parts

The “VR” image is created with the use of just 4 mirrors. 2 mirrors at the center, #12 & #13, split the camera view in half creating 2 images, a left eye view and a right eye view. While the left and right outer mirrors, #11 & #14, at eyes pupil distance, reflect back to the center the same objects in front of them, but seen at slightly different angles.

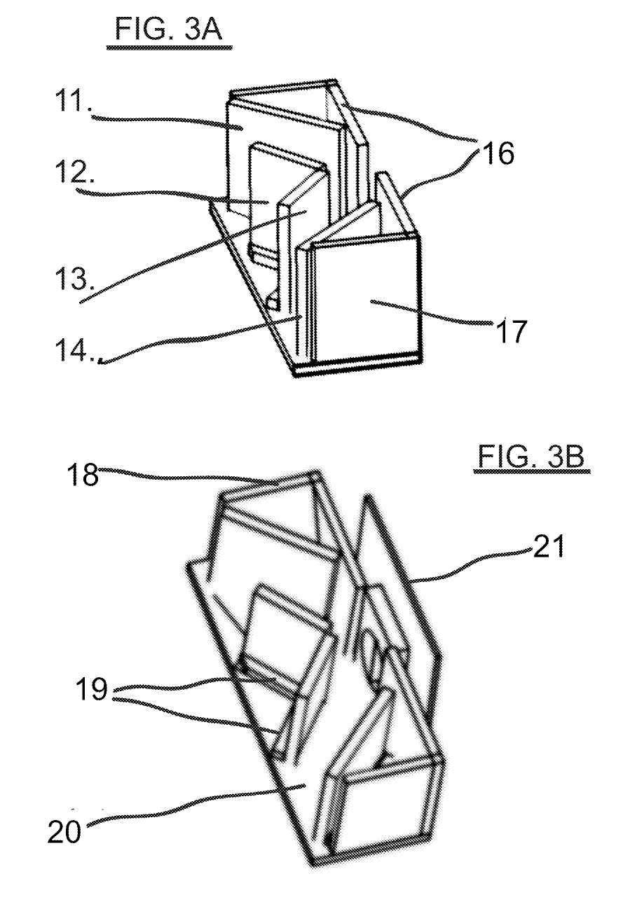

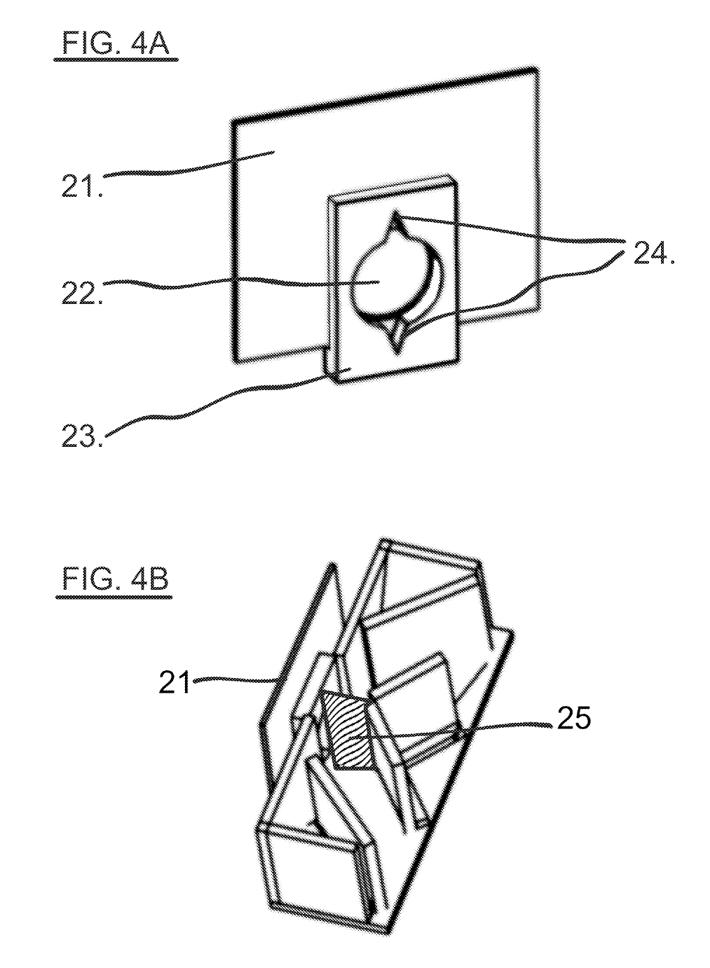

FIG. 2A and FIG. 2B show the old and newly created images as seen on the screen of today's smart cell phone.

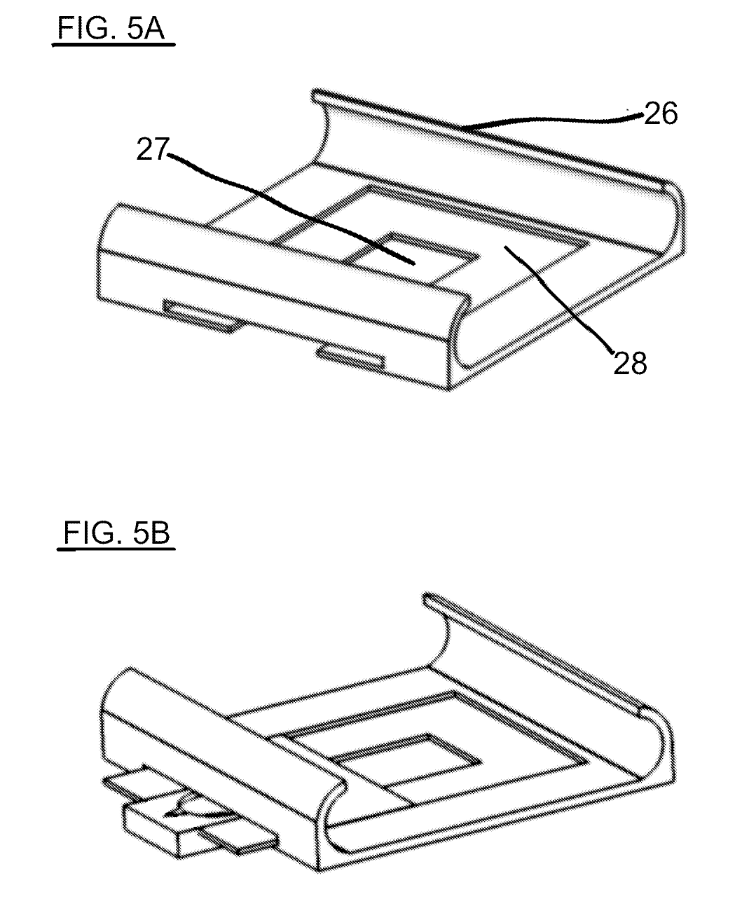

FIG. 3A to FIG. 5B show parts and dimensions for the embodiment of a smart cell phone.

FIG. 3A is called the Mirror Holder Assembly and its top is NOT shown for purpose of clarity. Shown are the 4 mirrors #'s 11, 12, 13, 14. The mirrors can be front surface or rear surface, plastic or glass. They could even be reflective prisms. For this embodiment, dimensions are to the reflective surface of rear surface mirrors 2.5 mm thick. Walls of the Assembly (#16 Rear) (#17 Left Wall) and FIG. 3B (#18 Right Wall). All the walls and mirrors are perpendicular to the Top and Bottom, #20, of the Mirror Holder Assembly. They are all 30 mm high. The both center mirrors are 10 mm from the back edge of the rear walls are 20 mm wide and angled 40 degrees outward. While the both outer mirrors start at the inside edge of the rear walls are 32 mm wide and angled 47 degrees forward. The distance between the center of the outer mirrors reflective surface, constitutes the eyes pupil distance and in, Virtual Reality Headsets, and this embodiment is set to 55 mm. The Bottom, #20, and the top identical (not shown) are 80 ×30 mm and contain the Mirror Holders, #19. Mirror Holders shown in FIG. 3B are 4 small rectangular solids (2×2×20 mm) protruding from the bottom, on which the back side of the mirror is fastened (glued), but they could be indents, holes, or walls or anything that can hold the mirrors in their precise location and angle. They could be part of the top, bottom or both. They could be as few as 4 (1 per mirror) or as many as 16 (2 at the bottom and 2 at the top of each mirror). FIG. 3B #21 shows the location of the Stage&Sled (one piece) in the Mirror Holder Assembly.

FIG. 4A shows the Stage&Sled #21 (one piece) alone. The sled half and is 50×40×1 mm thick. it is sized to fit loosely in the slide. While #23 is the stage half. It's 20×30×6 mm, and rises 5 mm above the sled. At center stage is the View Port Hole, #22, through which the front camera of the smart cell phone sees the left and right reflected images on the center mirrors. Also, on stage are 2 vertically positioned notches, #24, the Light Stop Separator Holder.

FIG. 4B #25 is the Light Stop Separator, a very thin piece of stiff plastic or metal. It is blackened and oriented vertically between the two center mirrors and the cell phone lens. It prevents light leakage between the left and right side of the Mirror Holder Assembly which causes image degradation. With mirrors and the top in place and the Light Stop Separator inside, the stage #23, is glued to the top, bottom and rear walls, leaving enough space between the rear walls and the sled (about 1.5 mm) for the now completed Mirror Holder Assembly to slide into the phone gripper.

FIG. 5A #26 The Gripper slips on to the cell phone or the cell phone case. It has an indent, #28, (the Slide on which the Sled moves). The Gripper also has a cutout #27 that is 21 mm wide for the stage (and connected Mirror Holder Assembly) to pass through.

FIG. 5B shows the relationship of the Gripper and the Stage&Sled.

While the Gripper can move left to right along the phone (in VR headsets the phone is held Horizontally). The Stage&Sled (one piece) slides up and down in the Gripper and connects to the Mirror Holder Assembly. The up and down and the left to right movement allows the View Port of the Mirror Holder Assembly to position directly in front of the lens of any cell phone.

### SUMMARY OF THE EMBODIMENTS

The smart cell phone embodiment seemed a good place to start. As a lens attachment to the smart cell phone It will create a three-dimensional image (FIG. 2B). That image can be in the form of a still picture, a video or a live stream and viewed on its self or any smart cell phone in a “Virtual Reality Headset”. Anyone with a smart cell phone can start taking 3D pictures and text them to their friends. It is my hope that once it is in the hands of others, creative people will make lots of fun games and apps. Some additional embodiments of the Virtual Veronica hardware, in the interest of fun, that I have already started working on:

1) A stand-alone light weight camera capable of streaming (via WIFI) with a light weight Virtual Veronica for use on a toy drone.

2) A VR headset with the Virtual Veronica built in so that two players can see only through each other's eyes.

What is claimed is:

1. An apparatus for capturing a 3-dimensional image on any simple single lens (lens system) camera, using 4 mirrors (or reflective surfaces) to create two images in place of said camera's single image. 2 mirrors at the center split the camera view in half creating 2 images, a left eye view and a right eye view. While the left and right outer mirrors, at eyes pupil distance apart, reflect back to them the same objects in front of them but seen from slightly different angles.

2. When said camera is part of a smart cell phone, the 3-dimensional image can be viewed directly as such in any Virtual Reality Headset such as Google Goggles™.
